(19) United States
(12) Patent Application Publication
(10) Pub. No.: US 2010/0245290 A1
(43) Pub. Date: Sep. 30, 2010

(54) Display Apparatus

(75) Inventors: Taro Iio, Kanagawa (JP); Yoichi Hirata, Kanagawa (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/438,718

(22) PCT Filed: Aug. 24, 2007
(86) PCT No.: PCT/JP2007/066488

§ 371 Date: Feb. 24, 2009

(30) Foreign Application Priority Data
Aug. 25, 2006 (JP) 2006-229530

(51) Int. Cl. G06F 3/042

(52) U.S. Cl. 345/175

(57) ABSTRACT

A control unit activates a touch sensor according to a predetermined state, for example, an open or closed state of a casing or a side key depressed state and changes, after the elapse of time for performing calibration (about 500 ms), the touch sensor to a state in which contact operation by the touch sensor can be performed. On the other hand, the control unit causes a sub-display unit to display a predetermined rendered image, for example, a character string “touch sensor is operable.” after the elapse of the time for performing calibration.

### TECHNICAL FIELD

The present invention relates to a display apparatus, and more particularly, to a display apparatus provided with a touch sensor that detects touch operation.

### BACKGROUND ART

Conventionally, various interfaces and configurations have been developed as operation input units of display apparatuses. For example, there is a technique for providing a rotary dial input device in a display apparatus and moving a cursor displayed on a display unit according to a rotation amount of the rotary dial input device (see Patent Document 1). However, in such a conventional technique, since a “rotary dial” involving physical and mechanical rotation is used, there is a problem in that malfunctions, failures, and the like tend to be caused by mechanical abrasion and the like, maintenance for the operation input unit is necessary, and a period of endurance is short.

Therefore, there are proposed techniques for using a touch sensor as an operation input unit not involving physical and mechanical rotation (see Patent Documents 2 and 3). In the proposed techniques, plural touch sensor elements are continuously arranged, operation involving movement is detected on the basis of contact detection from the respective touch sensor elements, and selection operation control for selecting one selection choice from plural selection choices is performed according to a result of the detection.
Patent Document 1: Japanese Patent Laid-Open No. 2003-280792
Patent Document 2: Japanese Patent Laid-Open No. 2005-522797
Patent Document 3: Japanese Patent Laid-Open No. 2004-311196

### SUMMARY OF INVENTION

### Technical Problem

However, the conventional display apparatus has a problem in that the touch sensor cannot be used for a fixed period when the display apparatus is shifted from a power supply OFF state to a power supply ON state. Therefore, in a period from a state in which a display displays a predetermined rendered image until the touch sensor changes to a usable state, regardless of the fact that the display displays the predetermined rendered image, since the touch sensor cannot be used, a user feels a sense of discomfort.

The present invention has been devised in view of such a problem and it is an object of the present invention to provide a display apparatus that can reduce a sense of discomfort in operation of a touch sensor.

### Solution to Problem

In order to attain the object, a display apparatus according to the present invention includes a display, a touch sensor that detects touch operation, and a control unit that performs control of the display and the touch sensor, characterized in that the control unit controls the display to display a predetermined rendered image after the touch sensor changes to a usable state.

It is preferable that, when the display apparatus changes to a predetermined state, the display and the touch sensor are activated, and the display changes to a displayable state before the touch sensor changes to the usable state. It is preferable that the control unit performs control for not displaying the predetermined rendered image or for displaying a rendered image indicating a standby state from time when the display changes to the displayable state until the touch sensor changes to the usable state. It is preferable that the display displays a rendered image related to content of operation of the touch sensor.

A display apparatus according to the present invention includes a touch sensor that detects touch operation and requires first predetermined time from the start of activation until the touch sensor changes to a usable state, a display that requires second predetermined time shorter than the first predetermined time from start of activation until the display changes to a displayable state, and a control unit that controls an operation of the touch sensor and an operation of the display, characterized in that the control unit performs control for starting, after starting the activation of the touch sensor, the activation of the display and causing the display to display a predetermined rendered image before the elapse of the first predetermined time.

It is preferable that the control unit performs control for causing the display to display, after the elapse of the first predetermined time, a rendering position changing object that can change a rendering position on the display according to a detection result of the touch operation of the touch sensor. It is preferable that the control unit performs control for causing the display to display a rendered image related to content of operation of the touch sensor.

Further, a display apparatus according to the present invention includes a touch sensor that detects touch operation, a display unit that performs display related to content of operation by the touch sensor, and a control unit that performs control of the display unit and the touch sensor, characterized in that the control unit controls the display unit to perform display after the touch sensor changes to a usable state.

### ADVANTAGEOUS EFFECTS ON INVENTION

The present invention can reduce a sense of discomfort in operation of a touch sensor by causing a display to display a predetermined rendered image after the touch sensor changes to a usable state.

### BRIEF DESCRIPTION OF DRAWINGS

FIG. 1 is a block diagram showing a basic configuration of a cellular phone terminal to which the present invention is applied;

FIG. 2 is a perspective view of a cellular phone terminal with sensor elements mounted on a casing;

FIG. 3 shows an example of display of a rendered image related to content of operation of a touch sensor unit;

FIG. 4 is a detailed functional block diagram of the cellular phone terminal to which the present invention is applied;

FIG. 5 is a block diagram showing a detailed configuration of a touch sensor function of the cellular phone terminal according to the present invention;

FIG. 6 is a plan view showing the arrangement of components of the cellular phone terminal according to the present invention;

FIG. 7 is a disassembled perspective view of the components of the cellular phone terminal shown in FIG. 5;

FIG. 8 is a schematic block diagram for explaining processing of contact detection data from the respective sensor elements in the cellular phone terminal according to the present invention;

FIG. 9 is a diagram for explaining a response of a sub-display unit in the case in which a user traces over the sensor elements;

FIG. 10 is a diagram for explaining a response of the sub-display unit in the case in which the user traces over the sensor elements;

FIG. 11 is a diagram for explaining timing of a state of use of a touch sensor and a display state of a sub-display unit according to a first embodiment;

FIG. 12 is a diagram showing an example of display of a predetermined rendered image;

FIG. 13 is a diagram for explaining timing of a state of use of a touch sensor and a display state of a sub-display unit according to a second embodiment;

FIG. 14 is a diagram for explaining timing of a state of use of a touch sensor and a display state of a sub-display unit according to a third embodiment;

FIG. 15 is a diagram showing an example of display of a rendered image indicating a standby state;

FIG. 16 is a diagram for explaining timing of a state of use of a touch sensor and a display state of a sub-display unit according to a fourth embodiment;

FIG. 17 is a diagram for explaining timing of a state of use of a touch sensor and a display state of a sub-display unit according to a fifth embodiment; and

FIG. 18 is a diagram showing an example of display of a rendering position changing object.

### DESCRIPTION OF EMBODIMENTS

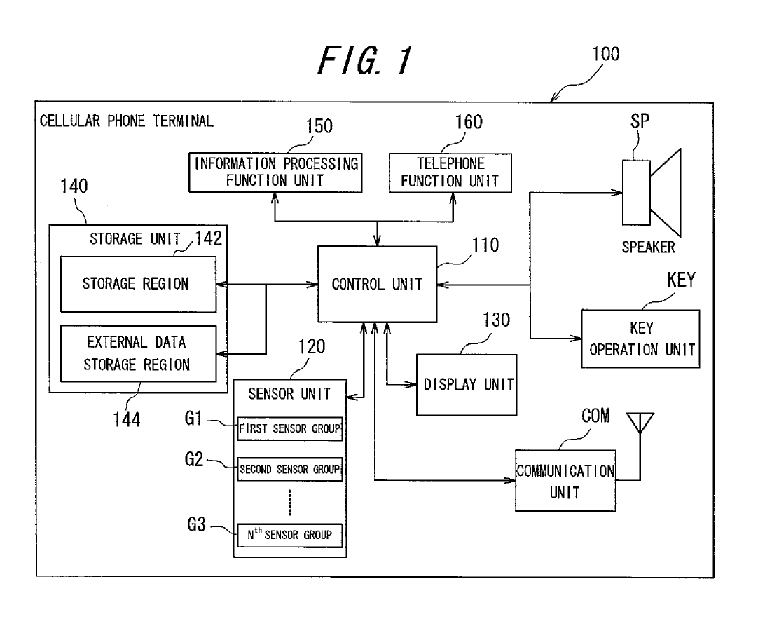

Embodiments of the present invention are explained with reference to the drawings. In the following explanation, as a typical example of a display apparatus, the present invention is applied to a cellular phone terminal. FIG. 1 is a block diagram showing the basic configuration of the cellular phone terminal to which the present invention is applied. A cellular phone terminal 100 shown in FIG. 1 includes a control unit 110, a sensor unit 120, a display unit 130 (a display), a storage unit (a flash memory, etc.) 140, an information processing function unit 150, a telephone function unit 160, a key operation unit KEY, a speaker SP, and a communication unit COM that is connected to a not-shown CDMA communication network and performs communication. Further, the sensor unit 120 includes, according to an application, “n” sensor element groups including plural sensor elements (e.g., a contact sensor, a detecting section of which is provided on an outer surface of an apparatus casing, and that detects contact and approach of an object such as a finger), i.e., a first sensor element group G1, a second sensor element group G2, and an nth sensor element group G3. The storing unit 140 includes a storage region 142 and an external data storage region 144. The control unit 110 and the information processing function unit 150 preferably include arithmetic means such as CPUs and software modules. Besides a serial interface unit SI, an RFID module RFID and an infrared-ray communication unit IR connected to the control unit 110 via the serial interface unit SI, and a camera 220 and a light 230 explained later, a microphone MIC, a radio module RM, a power supply PS, a power supply controller PSCON, and the like are connected to the control unit 110. However, these components are omitted in order to simplify the drawing.

Functions of the respective blocks in the block diagram of FIG. 1 are briefly explained. The control unit 110 detects, with the sensor unit 120, contact of an object by a finger of a user, stores detected information in the storage region 142 of the storing unit 140, and controls, with the information processing function unit 150, processing for the stored information. The control unit 110 causes the display unit 130 to display information corresponding to a processing result. Further, the control unit 110 controls the telephone function unit 160 for a normal call function, the key operation unit KEY (including a side key 240 explained later), and the speaker SP. The display unit 130 includes a sub-display unit ELD and a not-shown main display unit (a display unit provided in a position where the display unit is hidden in a closed state of the cellular phone terminal 100 and is exposed in an open state of the cellular phone terminal 100).

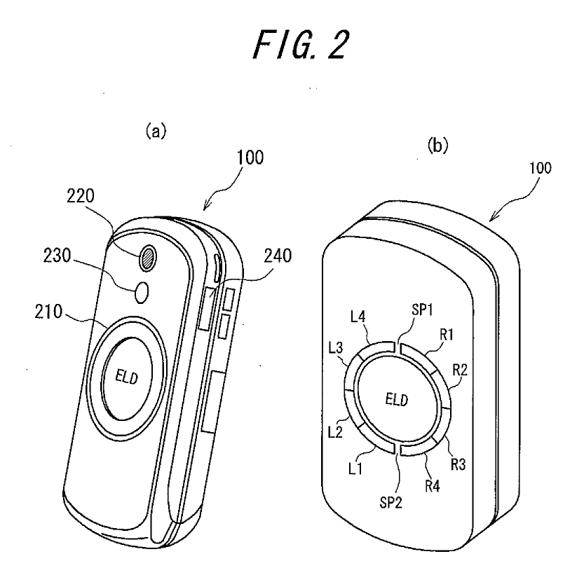

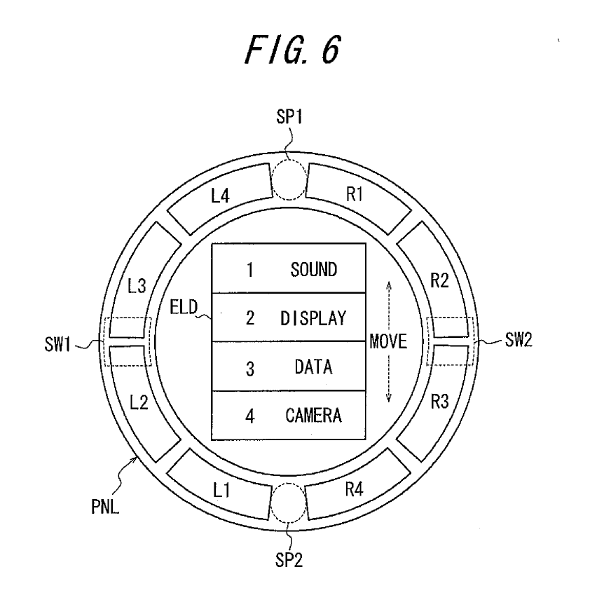

FIG. 2 is a perspective view of the cellular phone terminal having sensor elements mounted on a casing. In the cellular phone terminal 100, besides a closed state shown in FIG. 2, a hinge section can be pivoted and slid to form an open state. The touch sensor unit 210 is provided in a position where the touch sensor unit 210 can be operated even in the closed state. FIG. 2(a) is a perspective view showing an external appearance of the cellular phone terminal 100. The cellular phone terminal 100 includes the touch sensor unit 210 (on an external appearance, a panel PNL that covers the sensor unit 130, i.e., the sensor element groups G1 and G2 is seen (explained later with reference to FIG. 6)), the camera 220, the light 230, and the side key 240. FIG. 2(b) is a perspective view of the cellular phone terminal 100 in which, for explanation of operations of the touch sensor, the panel PNL is omitted and the arrangement of only the periphery of the sensor elements and the sub-display unit ELD is shown. As shown in the figure, sensor elements L1 to L4 and R1 to R4 are arranged along the circumference of the sub-display unit ELD. The sensor elements L1 to L4 configure the first sensor element group G1. The sensor elements R1 to R4 configure the second sensor element group G2. The first sensor element group G1 and the second sensor element group G2 are separated across separation sections SP1 and SP2. With respect to a layout of the first sensor element group G1, the sensor element group G2 has, across the sub-display unit ELD, a line symmetrical layout with a direction of the arrangement of selection candidate items set as a center line. In this configuration, an organic EL display is used as the sub-display unit ELD. However, for example, a liquid crystal display can also be used as the sub-display unit ELD. In this configuration, an electrostatic capacitance type contact sensor is used as the sensor elements. The side key 240 includes a tact switch arranged on a side of the casing.

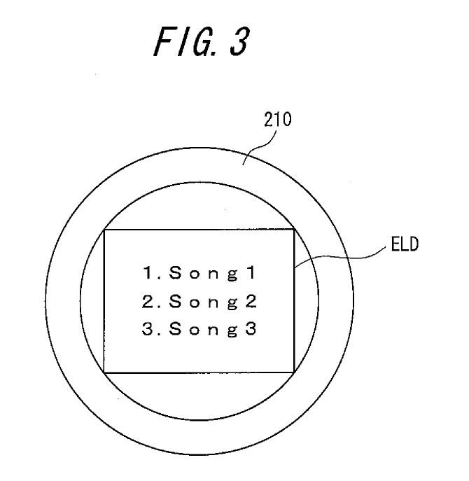

In the cellular phone terminal 100 of FIG. 2, the sub-display unit ELD displays a rendered image related to content of operation of a touch sensor unit 210. For example, when the cellular phone terminal 100 is used as a music player, titles of pieces of music that can be played are displayed on the sub-display unit ELD as selection candidate items. An example of display of the rendered image related to content of operation of the touch sensor unit 210 is shown in FIG. 3. The user operates the touch sensor unit 210 as an operation input unit to change electrostatic capacitances of the sensor elements L1 to L4 and R1 to R4, move items displayed on the sub-display unit ELD and an operation target region, and perform selection of a title of a piece of music. In this case, if the sensor elements are arranged around the sub-display unit ELD as shown in FIG. 2, the touch sensor does not occupy a large area of a mounting portion in an outer casing of a small display apparatus. The user can operate the sensor elements while looking at the display of the sub-display unit ELD.

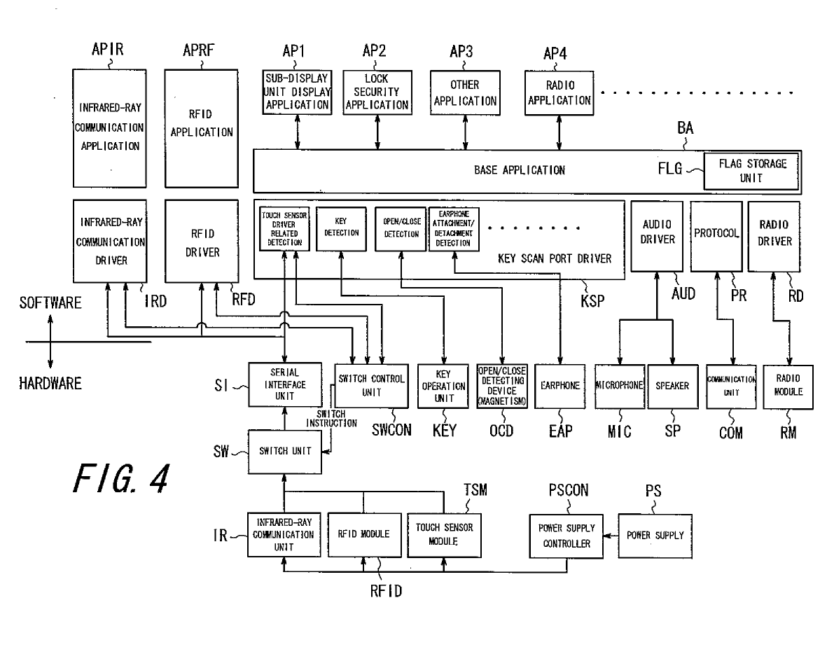

FIG. 4 is a detailed functional block diagram of the cellular phone terminal 100 to which the present invention is applied. It goes without saying that various kinds of software shown in FIG. 3 operate by being executed by the control unit 110 on the basis of programs stored in the storing unit 140 after a work area is provided on the same storing unit 140. As shown in the figure, functions of the cellular phone terminal are divided into a software block and a hardware block. The software block includes a base application BA having a flag storing section FLG, a sub-display unit display application AP1, a lock security application AP2, other applications AP3, and a radio application AP4. The software block further includes an infrared-ray communication application APIR and an RFID application APRF. When these applications control various kinds of hardware of the hardware block, the applications use an infrared-ray communication driver IRD, an RFID driver RFD, an audio driver AUD, a radio driver RD, and a protocol PR as drivers. For example, the audio driver AUD, the radio driver RD, and the protocol PR respectively control the microphone MIC, the speaker SP, the communication unit COM, and the radio module RM. The software block further includes a key scan port driver KSP that monitors and detects an operation state of the hardware and performs touch sensor driver related detection, key detection, open/close detection for detecting open and close of cellular phone terminals of a folding type and a slide type, earphone attachment and detachment detection, and the like.

The hardware block includes the key operation unit KEY including various buttons including a dial key and tact switches SW1 to SW4 explained later, an open/close detecting device OCD that detects open and close-on-the basis of an operation state or the like of the hinge section, the microphone MIC attached to an apparatus main body, a detachable earphone EAP, the speaker SP, the communication unit COM, the radio module RM, the serial interface unit SI, and a switch control unit SWCON. The switch control unit SWCON selects, according to an instruction from a relevant block of the software block, any one of the infrared-ray communication unit IR, the RFID module (a radio identification tag) RFID, and a touch sensor module TSM (a module of the sensor unit 120 and a set of components necessary in driving the sensor unit 120 such as an oscillation circuit) and switches the selection target pieces of hardware (IR, RFID, and TSM) such that the serial interface unit SI picks up a signal of the selection. The power supply PS supplies power to the selection target pieces of hardware (IR, RFID, and TSM) via the power supply controller PSCON.

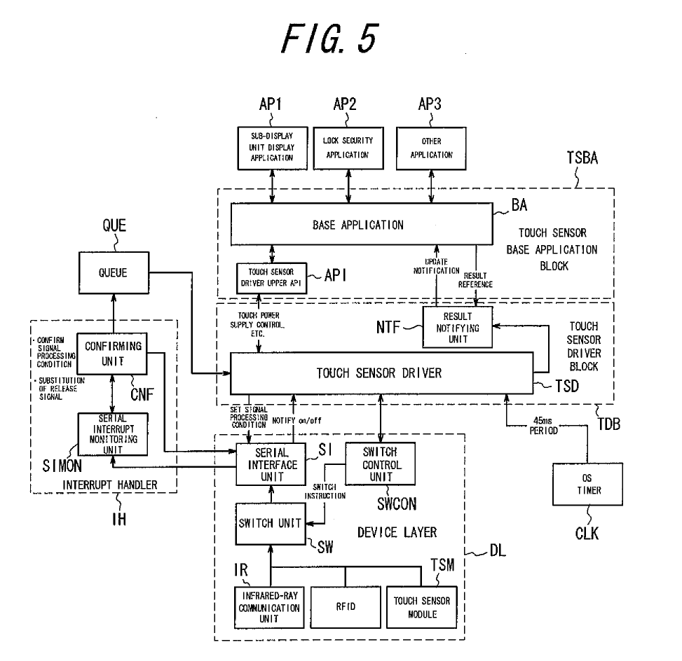

FIG. 5 is a block diagram showing a more detailed configuration of the touch sensor function of the cellular phone terminal 100 according to the present invention. As shown in the figure, the cellular phone terminal 100 includes a touch sensor driver block TDB, a touch sensor base application block TSBA, a device layer DL, an interrupt handler IH, a queue QUE, an OS timer CLK, and various applications AP1 to AP3. The touch sensor base application block TSBA includes a base application BA and a touch sensor driver upper application program interface API. The touch sensor driver block TDB includes a touch sensor driver TSD and a result notifying unit NTF. The device layer DL includes the switch control unit SWCON, a switch unit SW, the serial interface unit SI, the infrared-ray communication unit IR, the RFID module RFID, and the touch sensor module TSM. The interrupt handler IH includes a serial interrupt monitoring unit SIMON and a confirming unit CNF.

Next, functions of the respective blocks are explained. In the touch sensor base application block TSBA, the base application BA and the touch sensor driver upper application program interface API communicate each other about whether the touch sensor should be activated. The base application BA is an application as a base of the sub-display unit display application AP1 that is an application for a sub-display unit, the lock security application AP2 that is an application for locking the cellular phone terminal 100 for security protection, and the other applications AP3. When the base application BA is requested by the respective applications to activate a touch sensor, the base application BA requests the touch sensor driver upper application program interface API to activate the touch sensor. The sub-display unit is the sub-display unit ELD shown in the respective figures and indicates a display unit provided in a center area of the sensor element group annularly arranged in the cellular phone terminal 100 in this embodiment.

When a request for the activation of the touch sensor is received, the touch sensor driver upper application program interface API checks with a block (not shown), which manages the activation of applications in the base application BA, whether the activation of the touch sensor is possible. The touch sensor driver upper application program interface API checks presence or absence of lighting of the sub-display unit ELD indicating that selection of an application is executed or a flag indicating the activation of an application, for which the activation of the touch sensor is set impossible in advance, such as an FM radio or other applications attached to the cellular phone terminal 100. As a result, when it is determined that the activation of the touch sensor is possible, the touch sensor driver upper application program interface API requests the touch sensor driver TSD to activate the touch sensor module TSM. In other words, practically, the touch sensor driver upper application program interface API starts power supply to the touch sensor module TSM from the power supply PS via the power supply controller PSCON.

When the activation of the touch sensor is requested, the touch sensor driver TSD requests the serial interface unit SI in the device layer DL to perform control to open a port to the touch sensor driver TSD in the serial interface unit SI.

Thereafter, the touch sensor driver TSD performs control such that a signal having information concerning a sensing result of the touch sensor (hereinafter referred to as contact signal) is output to the serial interface unit SI at a period of 20 ms by an internal clock of the touch sensor module TSM.

The contact signal is output as an 8-bit signal corresponding to each of the eight sensor elements, i.e., the sensor elements L1 to L4 and R1 to R4. When each of the sensor elements senses contact, the contact signal is a signal formed by setting “flag: 1” representing the contact detection in bits corresponding to the sensor element that sense the contact. The contact signal is formed by a string of these bits. In other words, information indicating “which of the sensor elements” is “contact or non-contact” is included in the contact signal.

The serial interrupt monitoring unit SIMON in the interrupt handler IH extracts the contact signal output to the serial interface unit SI. The confirming unit CNF performs confirmation of True/False of the extracted contact signal according to conditions set in advance in the serial interface unit SI and inputs only data of a True signal to the queue QUE (classification of True/False of a signal is explained later). The serial interrupt monitoring unit SIMON also performs monitoring of other interrupt events of the serial interface unit SI during the activation of the touch sensor such as occurrence of depression of the tact switch.

When the detected contact is first contact, the monitoring unit SIMON inputs a signal meaning “press” to the queue QUE before the contact signal (queuing). Thereafter, the monitoring unit SIMON performs update of the contact signal at a clock 40 ms period by an OS timer CLK of an operation system. When contact is not detected for a predetermined number of times, the monitoring unit SIMON inputs a signal meaning “release” to the queue QUE. This makes it possible to monitor movement of contact detection among the sensor elements from the start of contact until the release. The “first contact” indicates an event in which a signal having “flag: 1” is generated in a state in which there is not data in the queue QUE or when nearest input data is “release”. According to these kinds of processing, the touch sensor driver TSD can learn a detection state of the sensor elements in a section from “press” to “release”.

At the same time, when the contact signal output from the touch sensor is a signal satisfying conditions for being False, the monitoring unit SIMON simulatively generates a signal meaning “release” and inputs the signal to the queue QUE. As the conditions for being False, “when contact is detected by discontinuous two sensor elements”, “when interrupt occurs during the activation of the touch sensor (e.g., a turn-on/turn-off state of the sub-display unit ELD is changed according to notification of mail reception or the like)”, “when key depression occurs during the activation of the touch sensor”, or a contact is detected across sensor element groups as described later or the like is set.

For example, when contact is simultaneously detected by adjacent two sensor elements such as the sensor elements R2 and R3, as in the case in which a single element is detected, the monitoring unit SIMON inputs a contact signal with a flag set in bits corresponding to the elements that detect the contact to the queue QUE.

The touch sensor driver TSD reads out the contact signal from the queue QUE at a 45 ms period and determines, according to the read-out contact signal, the elements that detect the contact. The touch sensor driver TSD determines “an element from which contact is started”, “detection of a moving direction (clockwise/counterclockwise) of contact”, and “a moving distance from press to release” taking into account a change in the contact determined by contact signals sequentially read out from the queue QUE and a positional relation with the elements that detect the contact. The touch sensor driver TSD writes a result of the determination in the result notifying unit NTF and notifies the base application BA to update the result.

The moving direction and moving distance of contact are determined by a combination of detection of the adjacent sensor element and detection of each of the sensor elements, and various methods (determination rules) can be applied to this. For example, when contact transfers from a certain sensor element (e.g., R2) to the adjacent sensor element (R2 and R3 in the case of this example), this is determined as the movement by one element (one item in the sub-display unit) in that direction.

As explained above, when the update of the result is notified to the base application BA by the touch sensor driver TSD, the base application BA checks the result notifying unit NTF and notifies the application, which is a higher application and requires the touch sensor result (the display unit display application AP1 for menu screen display in the sub-display unit, the lock security application AP2 for lock control, and the like), of the content of the information notified to the result notifying unit NTF.

FIG. 6 is a plan view showing the arrangement of components of, in particular, the touch sensor unit 210 of the cellular phone terminal 100 according to the present invention. For convenience of illustration and explanation, only a part of the components are illustrated and explained. As shown in the figure, the annular dielectric panel PNL is arranged along the circumference of the sub-display unit ELD including organic EL elements. The panel PNL is suitably formed sufficiently thin not to affect the sensitivity of sensor elements provided below the panel PNL. Below the panel PNL, the eight sensor elements L1 to L4 and R1 to R4 of the electrostatic capacitance type, which can sense contact/approach of a finger of a human body, are arranged substantially annularly. The four sensor elements L1 to L4 on the left side configure the first sensor element group G1 and the four sensor elements R1 to R4 on the right side configure the second sensor element group G2. Clearances (spaces) are provided among adjacent sensor elements in the respective sensor element groups such that the adjacent sensor elements do not interfere with a contact detection function. When sensor elements of a non-interfering type are used, the clearances are unnecessary. The separation section SP1 as a clearance larger than (e.g., twice or more as long as) the clearances is provided between the sensor element L4 located at one end of the first sensor element group G1 and the sensor element R1 located at one end of the second sensor element group G2. The separation section SP2 same as the separation section SP1 is provided between the sensor element L1 located at the other end of the first sensor element group G1 and the sensor element R4 located at the other end of the second sensor element group G2. With such separation sections SP1 and SP2, the first sensor element group G1 and the second sensor element group G2 are prevented from interfering with each other when the sensor element groups are caused to separately function.

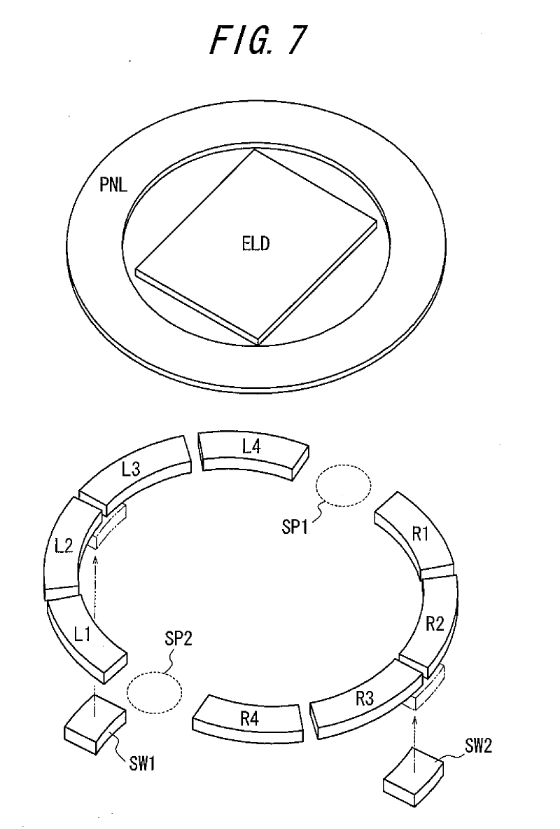

The respective sensor elements of the first sensor element group G1 are arranged in an arc shape. The center of the tact switch SW1 is arranged below the center of this arc, i.e., the middle of the sensor elements L2 and L3. Similarly, the center of the tact switch SW2 is arranged below the center of an arc formed by the respective sensor elements of the second sensor element group G2, i.e., the middle of the sensor elements R2 and R3 (see FIG. 7). Since the tact switches are arranged in substantially the centers in the arranging direction of the sensor element groups, which are in positions not causing the user to associate the switches with directionality, the user can easily grasp that the tact switches are switches for performing operation not directly related to a direction indication by operation involving movement having directionality of a finger by the user on the sensor elements. In other words, if the tact switches are arranged at ends (e.g., L1 and L4) rather than in the centers in the arranging directions of the sensor element groups, since this causes the user to associate the tact switches with directionality toward the end sides, the user tends to misunderstand that the tact switches are “switches” that are pressed long in order to, for example, continue a moving operation by the touch sensor. On the other hand, if the tact switches are arranged in the centers in the arranging directions of the sensor element groups as in this embodiment, the likelihood of occurrence of such misunderstanding is reduced and a more comfortable user interface is provided. Since the tact switches are arranged below the sensor elements and are not exposed to the outer surface of the apparatus, as the external appearance of the apparatus, the number of points of the operation unit exposed to the outside can be reduced. This gives the user a sophisticated impression in that complicated operation is not required. When the switches are provided in places other than below the panel PNL, it is necessary to separately provide through holes in the casing of the apparatus. However, a fall in casing strength could occur depending on positions where the through holes are provided. In this configuration, since the tact switches are arranged below the panel PNL and the sensor elements, it is unnecessary to provide new through holes and the fall in casing strength is suppressed.

For example, when the user sequentially traces the sensor elements L1, L2, L3, and L4 with a finger in an arc shape upward, an item displayed as a selection target region (reversing display, highlighting display in a different color, etc.) among selection candidate items (in this case, sound, display, data, and camera) displayed on the sub-display unit ELD is sequentially changed to items displayed above or the selection candidate items are scrolled upward. When a desired selection candidate item is displayed as the selection target region, the user can depress the tact switch SW1 across the panel PNL and the sensor elements L2 and L3 to perform selection determination or can depress the tact switch SW2 to change display itself to another screen. In other words, the panel PNL has flexibility sufficient for depressing the tact switches SW1 and SW2 or is attached to the apparatus casing to be slightly tiltable and has a role of a plunger for the tact switches SW1 and SW2.

FIG. 7 is a disassembled perspective view of the components, in particular, the touch sensor unit 210 of the cellular phone terminal shown in FIGS. 2 and 6. As shown in the figure, the panel PNL and the display unit ELD are arranged in a first layer forming the outer surface of the terminal casing. The sensor elements L1 to L4 and R1 to R4 are arranged in a second layer located below the panel PNL in the first layer. The tact switches SW1 and SW2 are arranged in a third layer located below a space between the sensor elements L2 and L3 in the second layer and below a space between the sensor elements R2 and R3.

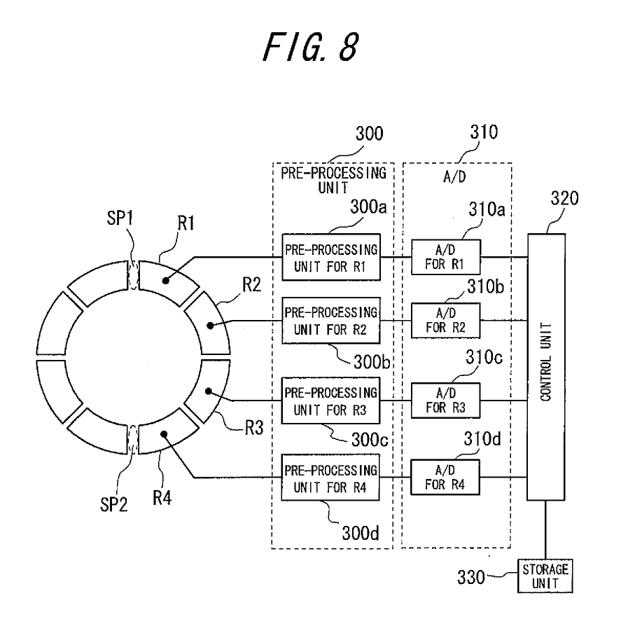

FIG. 8 is a schematic block diagram for explaining processing of contact detection data from the respective sensor elements in the cellular phone terminal according to the preset invention. For simplification of explanation, only the sensor elements R1 to R4 are shown. However, the same applies to the sensor elements L1 to L4. A high frequency is applied to each of the sensor elements R1 to R4. A high frequency state recognized by calibrating the sensor elements R1 to R4 taking into account a change in a fixed stray capacitance is set as a reference in the sensor elements R1 to R4. When a pre-processing unit 300 (a pre-processing unit for R1 300a, a pre-processing unit for R2 300b, a pre-processing unit for R3 300c, and a pre-processing unit for R4 300d) detects fluctuation in the high frequency state based on a change in an electrostatic capacitance due to contact of a finger or the like, a detection signal is transmitted to an A/D converter 310 (an A/D converter for R1 310a, an A/D converter for R2 310b, an A/D converter for R3 310c, and an A/D converter for R4 310d) and converted into a digital signal indicating the contact detection. The digitized signal is transmitted to the control unit 320 as a set of collected signals of the sensor element group and stored in a storing unit 330 as information held by the signal. Thereafter, this signal is transmitted to the serial interface unit and the interrupt handler and, after being converting into a signal readable by the touch sensor driver in the interrupt handler, the signal after the conversion is input to the queue. The control unit 320 performs, on the basis of information stored in the storing unit 330, detection of a direction at a point when contact is detected in two or more of the adjacent sensor elements.

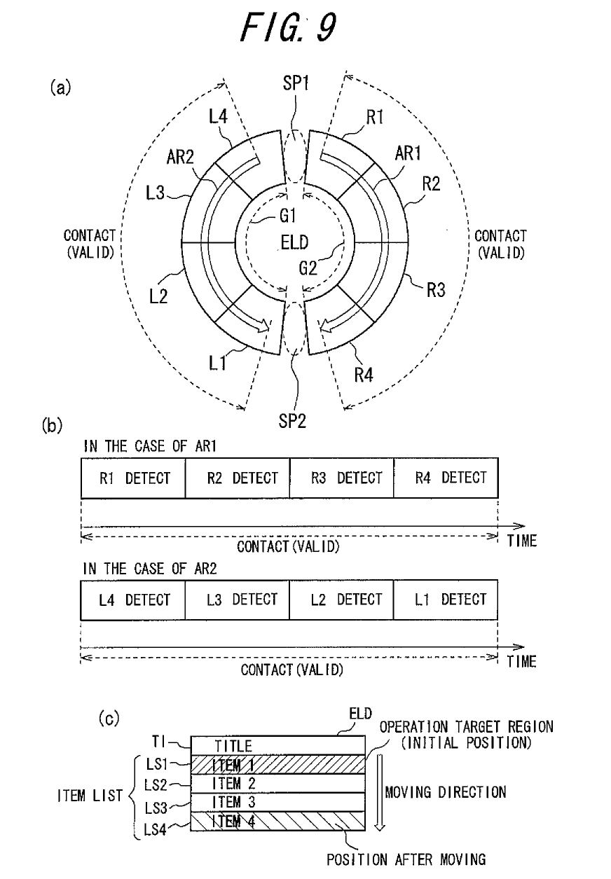

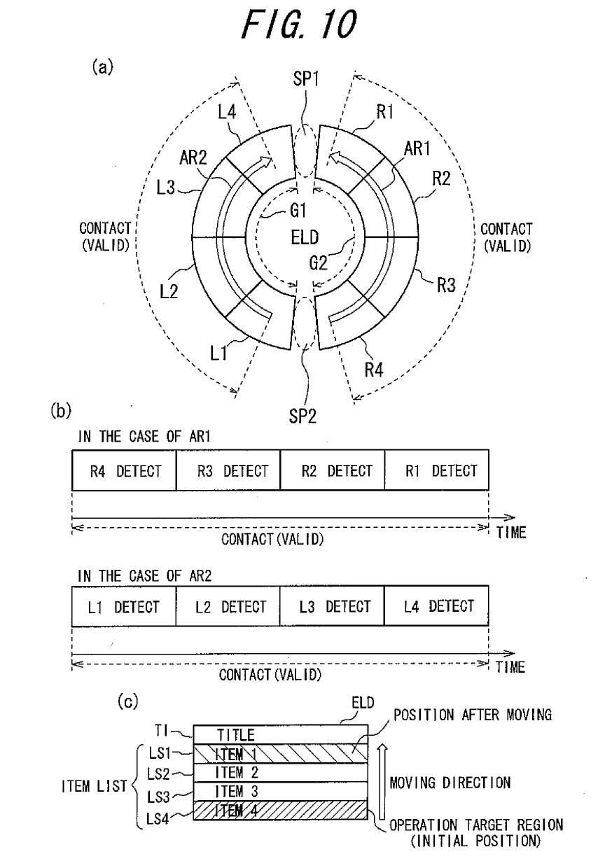

FIGS. 9 and 10 are diagrams for explaining a response of the sub-display unit in the case in which the user traces over the sensor elements. In FIGS. 9 and 10, (a) is a schematic diagram showing, for simplification of explanation, only the sub-display unit mounted on the cellular phone terminal and the sensor elements arranged side by side along the circumference of the sub-display unit, (b) is a diagram showing the sensor elements detected with a lapse of time, and (c) is a diagram showing a positional change of the operation target region of the sub-display unit ELD corresponding to the detected sensor elements. In (a) of these figures, the sensor elements, the sensor element groups, and the separation sections are denoted by reference numerals and signs same as those in FIG. 2 (b). Further, in the display of the sub-display unit ELD in (c), TI denotes a title of the item list displayed by the sub-display unit and LS1 to LS4 denote selection candidate items (e.g., several lines that can be scrolled). Further, in the sub-display unit in (c), concerning an item in a state of an operation target, a cursor is placed on the item, or the item itself is highlighted by reversing display or the like such that the item can be identified as the present operation target region. In these figures, the items displayed as the operation target region are highlighted by applying hatching thereto. For convenience of explanation, “moving target” is explained in only the operation target region. However, when the item itself is moved (scrolled), the sub-display unit operates according to the same principle.

In FIG. 9(a), when the user continuously traces the respective elements using contact means such as a finger in an up to down direction indicated by an arrow AR1, the control unit 110 detects the contact as operation involving movement with the lapse of time shown in (b). In this case, the operation is detected in order of the sensor elements R1, R2, R3 and R4. The continuous contact from R1 to R4 is detected by the two or more of the adjacent sensor elements. Therefore, a direction is detected and the operation target region moves on a list displayed on the sub-display unit ELD according to the number of times of transition over the adjacent sensor elements and the direction. In this case, as shown in (c), the operation target region moves by three items downward from the item LS1 in an initial position to the item LS4. The operation target region is represented by hatching. A position with a small hatching pitch is the initial position and a position with a large hatching pitch is a position after the movement. In this way, with this configuration, since “the operation target region” of the sub-display unit “moves downward” in the same manner as “a downward indication operation of a finger” of the user, the user feels as if the user moved the operation target region with a finger of the user at will. In other words, operation feeling as the user intends can be obtained.

Similarly, when the sensor elements are traced in a direction indicated by an arrow AR2 in the figure (a), the sensor elements L4, L3, L2 and L1 among the sensor elements detect contact as operation involving movement in this order as shown in (b). The contact in this case is the contact that transitions over three adjacent sensor elements up to down like the contact indicated by the arrow AR1. Therefore, as shown in (c), the operation target region moves by three items downward from the item LS1 to the item LS4.

When the sensor elements are traced in the down to up direction (the counter clock direction) indicated by the arrow AR1 in FIG. 10 (a), the sensor elements R4, R3, R2 and R1 among the sensor elements detect the contact as operation involving movement in this order as shown in (b). The contact in this case is contact that transitions over three adjacent sensor elements down to up. Therefore, the operation target region moves by three items from the item LS4 to the item LS1 upward as shown in (c).

Similarly, when the sensor elements are traced in the down to up direction (the clockwise direction) indicated by the arrow AR2 in the figure (a), the sensor elements L1, L2, L3 and L4 among the sensor elements detect the contact as operation involving movement in this order as shown in (b). The contact in this case is contact that transitions over three adjacent sensor elements down to up like the contact indicated by the arrow AR1. Therefore, the operation target region moves by three items from the item LS4 to the item LS1 upward as shown in (c).

Next, a relation between timing when touch operation by the touch sensor unit 210 (the touch sensor) can be performed and timing of rendered image display of the sub-display unit ELD (the display) is explained. The touch sensor unit 210 (the touch sensor) includes the sensor elements of the electrostatic capacitance type. Therefore, time (predetermined time) of about 500 ms is required to perform calibration (internal initialization) after a power supply is turned on. During that time, detection in the touch sensor unit 210 cannot be performed and, in particular, when the sub-display unit ELD is in the ON state, the user feels a sense of discomfort in operation. The calibration is an operation for measuring a reference capacitance value of the sensor elements (since the sensor elements of the electrostatic capacitance type are adapted to detect an operation state on the basis of a change in the reference capacitance value, it is necessary to grasp the reference capacitance value when the sensor elements are used). In the present invention, the sense of discomfort in operation of the touch sensor unit 210 is reduced by setting the timing when touch operation by the touch sensor unit 210 can be performed and timing of rendered image display of the sub-display unit ELD different. Activation time of the sub-display unit ELD (time from the start of activation until the sub-display unit ELD changes to the displayable state (the second predetermined time)) is shorter than 500 ms, which is calibration time of the touch sensor unit 210.

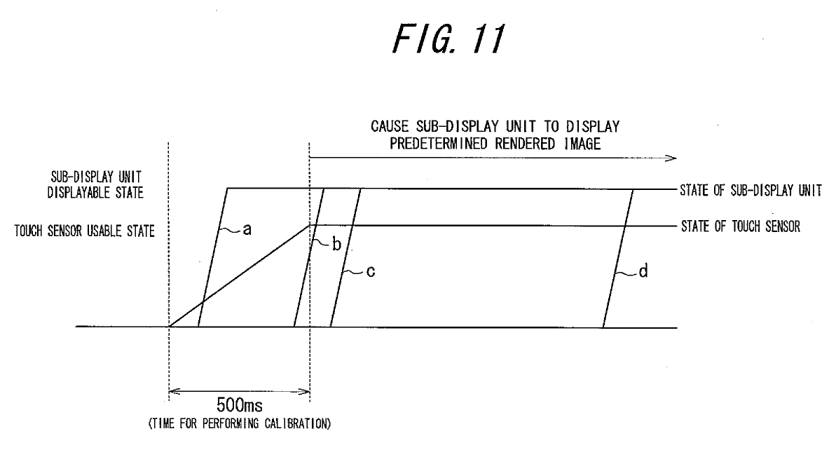

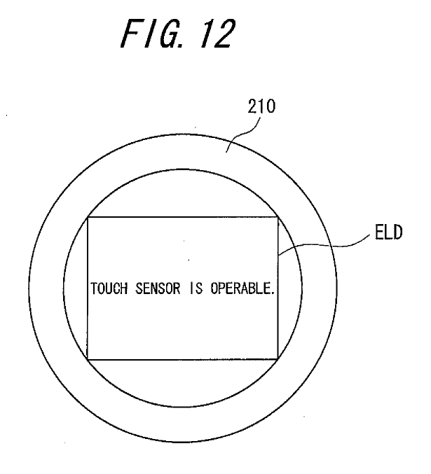

FIG. 11 is a diagram for explaining timing of a state of use of the touch sensor unit 210 (the touch sensor) and a display state of the sub-display unit ELD according to a first embodiment. As shown in FIG. 11, the control unit 110 activates the touch sensor unit 210 according to a predetermined state, for example, a closed state of the casing or a side key depressed state and, when it is determined with a not-shown timer that the time (about 500 ms) for performing calibration has elapsed, changes the touch sensor unit 210 to a state in which the contact operation by the touch sensor unit 210 (the touch sensor) can be detected (the usable state). On the other hand, the control unit 110 causes the sub-display unit ELD to display a predetermined rendered image after the elapse of the time for performing calibration. In the figure, “a” indicates a case in which, before the elapse of the time, the sub-display unit changes to a state in which a rendered image can be displayed (the displayable state). “b”, “c”, and “d” indicate a case in which, after the elapse of the time for performing calibration, the sub-display unit changes to the displayable state. In both the cases, the control unit 110 causes the sub-display unit ELD to display the predetermined rendered image after the elapse of the time for performing calibration (in the case of “a”, although the sub-display unit ELD is in the displayable state before the elapse of the time for performing calibration, the sub-display unit ELD performs predetermined rendering only after the elapse of the time for performing calibration). An example of display of the predetermined rendered image is shown in FIG. 12. For example, a character string “touch sensor is operable.” is displayed on the sub-display unit ELD. Consequently, the user can see that at least operation of the touch sensor unit 210 is possible at a stage when the predetermined rendered image is displayed on the sub-display unit ELD. Display content on the sub-display unit ELD is not limited to this. Some display only has to be performed. The predetermined state is not limited to the closed state and the side key depressed state and may be other states. In short, some state in which the activation of the touch sensor unit 210 (the touch sensor) is, for example, required or desired only has to be set as a trigger.

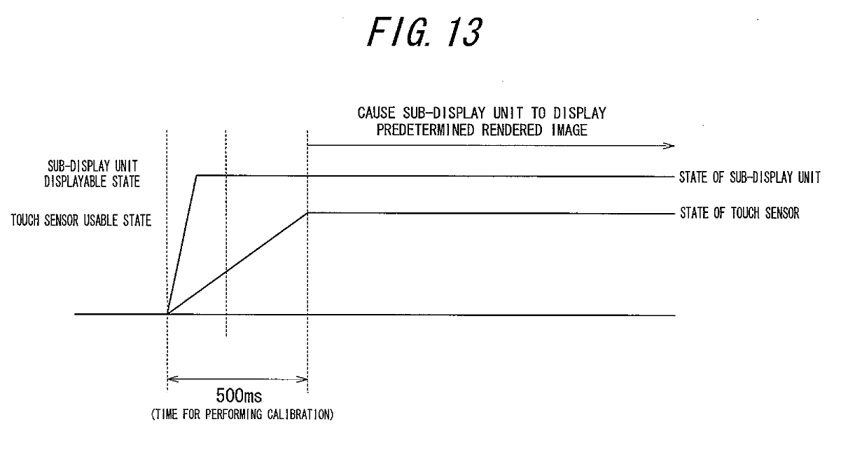

FIG. 13 is a diagram for explaining timing of a state of use of the touch sensor unit 210 and a display state of the sub-display unit ELD according to a second embodiment. As shown in FIG. 13, when the control unit 110 detects the closed state of the casing or the side key depressed state, the control unit 110 activates the touch sensor in association with the activation of the sub-display unit ELD. This makes it possible to control both the sub-display unit ELD and the touch sensor unit 210 (the touch sensor) in association with each other with the predetermined state as a trigger and simplify control.

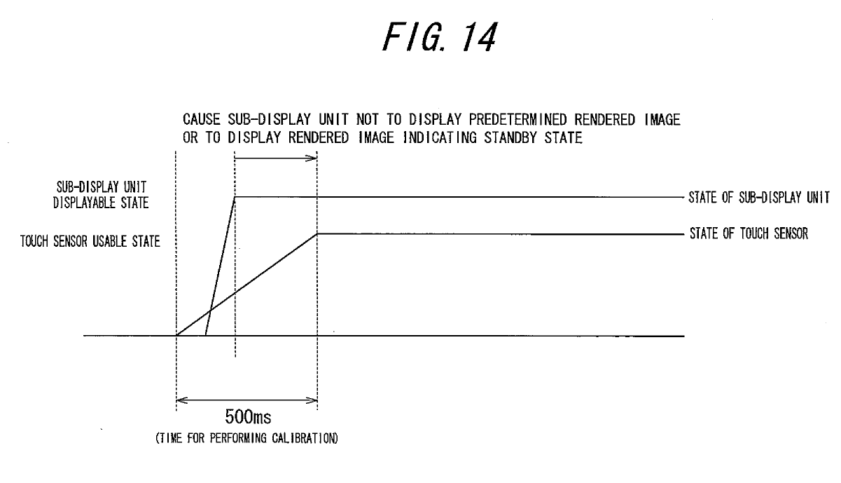

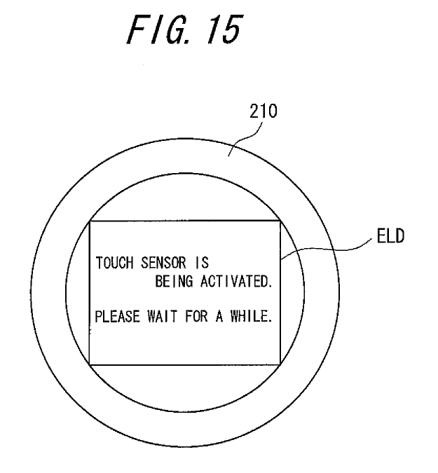

FIG. 14 is a diagram for explaining timing of a state of use of the touch sensor unit 210 (the touch sensor) and a display state of the sub-display unit ELD according to a third embodiment. As shown in FIG. 14, the control unit 110 activates, after the elapse of the time for performing calibration, the touch sensor unit 210 (the touch sensor) according to the closed state of the casing, the side key depressed state, or the like and changes the touch sensor unit 210 (the touch sensor) to the usable state. On the other hand, the control unit 110 changes the sub-display unit ELD to the displayable state before the elapse of the time for performing calibration and, during a period in which the calibration is performed, causes the sub-display unit ELD not to display the predetermined rendered image or to display a rendered image indicating a standby state (a rendered image indicating that the touch sensor is put on standby until the touch sensor changes to the usable state). An example of the display of the rendered image indicating the standby state is shown in FIG. 15. For example, a character string “touch sensor is being activated. Please wait for a while.” is displayed on the sub-display unit ELD. The user can learn the usable state of the touch sensor unit 210 (the touch sensor) on the basis of the predetermined rendered image on the sub-display unit ELD. In other words, it is possible to eliminate a harmful effect that the touch sensor unit 210 (the touch sensor) cannot be used regardless of the fact that a rendered image is displayed on the sub-display unit ELD.

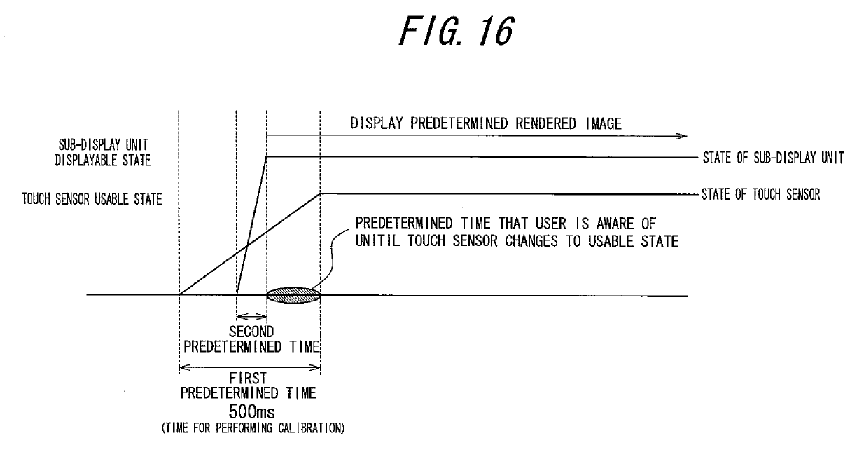

FIG. 16 is a diagram for explaining timing of a state of use of the touch sensor unit 210 (the touch sensor) and a display state of the sub-display unit ELD according to a fourth embodiment. As shown in FIG. 16, the control unit 110 activates the touch sensor unit 210 (the touch sensor) according to the closed state of the casing, the side key depressed state, or the like and changes the touch sensor unit 210 (the touch sensor) to the usable state after the elapse of the time for performing calibration (the first predetermined time). On the other hand, the control unit 110 activates the sub-display unit ELD after activating the touch sensor unit 210 (the touch sensor) and causes the sub-display unit ELD to display the predetermined rendered image before the elapse of the time for performing calibration. Consequently, time from the display of the predetermined rendered image by the sub-display unit ELD until the touch sensor unit 210 (the touch sensor) is activated is reduced to be shorter than 500 ms. In other words, it is possible to reduce awareness of predetermined time until the touch sensor unit 210 (the touch sensor) changes to the usable state. The activation of the sub-display unit ELD is set such that the sub-display unit ELD changes to the displayable state before the touch sensor unit 210 (the touch sensor) changes to the usable state. The predetermined rendering on the sub-display unit ELD may be performed at any time as long as the predetermined rendering is performed after the sub-display unit ELD changes to the displayable state and before the touch sensor unit 210 (the touch sensor) changes to the usable state.

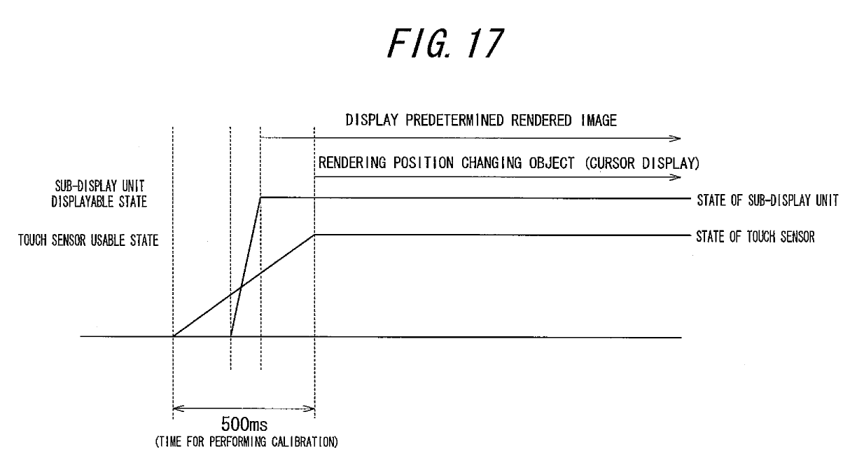

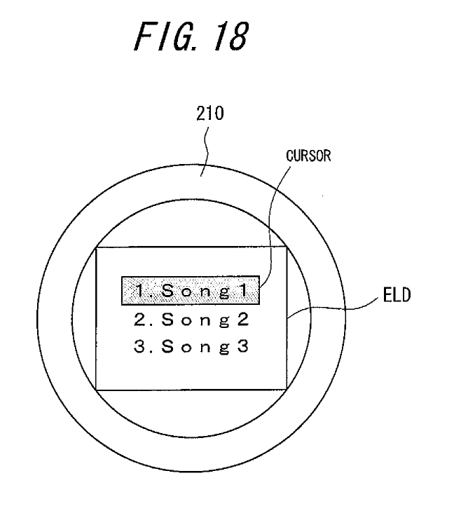

FIG. 17 is a diagram for explaining timing of a state of use of the touch sensor unit 210 (the touch sensor) and a display state of the sub-display unit ELD according to a fifth embodiment. As shown in FIG. 17, the control unit 110 activates the touch sensor unit 210 (the touch sensor) according to the closed state of the casing, the side key depressed state, or the like and changes the touch sensor unit 210 (the touch sensor) to the usable state after the elapse of the time for performing calibration. On the other hand, the control unit 110 activates the sub-display unit ELD after activating the touch sensor unit 210 (the touch sensor) and causes the sub-display unit ELD to display the predetermined rendered image before the elapse of the time for performing calibration. After the elapse of the time for performing calibration, the control unit 110 causes the sub-display unit ELD to display, for example, a cursor or a pointer (a rendering position changing object) that can change a rendering position on the sub-display unit ELD according to a detection result of contact operation on the touch sensor unit 210 (the touch sensor). An example of display according to this embodiment is shown in FIG. 18. Selection candidate items are displayed on the sub-display unit ELD as the predetermined rendered image after the touch sensor unit 210 is activated. Thereafter, when the calibration of the touch sensor unit 210 is finished, the cursor is displayed on the sub-display unit ELD to make it possible to identify a present operation target region. Consequently, according to the display of the cursor or the pointer, the user can learn timing when the touch sensor can be used.

The present invention has been explained on the basis of the drawings and the embodiments. However, the present invention is not limited to the drawings and the embodiments and various modifications and alterations are possible. Therefore, it should be noted that the modifications and the alterations are included in the scope of the present invention. For example, the functions included in members, means, and steps can be rearranged not to be logically inconsistent with one another. It is possible to combine plural means, steps, or the like into one or divide the means, the steps, or the like. For example, in the embodiments, the sensor element layout provided in the annular shape is explained. However, sensor element groups arranged in a C shape may be arranged to be opposed to one another across the display unit. In the embodiments, the sensor element groups arranged on the left and right are explained. However, the sensor element groups may be arranged as upper and lower two sensor element groups. In the embodiments, the cellular phone terminal is explained as the example. However, the present invention can be widely applied to portable electronic apparatuses such as a portable radio terminal other than a telephone, a PDA (persona digital assistance), a portable game machine, a portable audio player, a portable video player, a portable electronic dictionary, and a portable electronic book viewer. In the embodiments, the electrostatic capacitance contact sensor is explained as the sensor elements. However, sensor elements of the thin-film resistance type explained above, an optical system for sensing contact according to fluctuation in a light reception amount, an SAW system for sensing contact according to attenuation of a surface acoustic wave, and an electromagnetic induction system for sensing contact according to occurrence of an induction current may also be used. Depending on a type of a contact sensor, pointing apparatuses such as a dedicated pen other than a finger is used. The principle of the present invention can also be applied to a portable electronic apparatus mounted with such a contact sensor.

### CROSS REFERENCE TO RELATED APPLICATION

The present application claims the benefit of priority from Japanese Patent Application No. 2006-229530 (filed on Aug. 25, 2006); the entire contents of which are incorporated herein by reference.

1. A display apparatus comprising:
a display;
a touch sensor that detects touch operation; and
a control unit that performs control of the display and the touch sensor, characterized in that
the control unit controls the display to display a predetermined rendered image after the touch sensor changes to a usable state.

2. The display apparatus according to claim 1, characterized in that, when the display apparatus changes to a predetermined state, the display and the touch sensor are activated, and the display changes to a displayable state before the touch sensor changes to the usable state.

3. The display apparatus according to claim 2, characterized in that the control unit performs control for not displaying the predetermined rendered image or for displaying a rendered image indicating a standby state from time when the display apparatus changes to the displayable state until the touch sensor changes to the usable state.

4. The display apparatus according to claim 1, characterized in that the display displays a rendered image related to content of operation of the touch sensor.

5. A display apparatus comprising:
a touch sensor that detects touch operation and requires first predetermined time from start of activation until the touch sensor changes to a usable state;
a display that requires second predetermined time shorter than the first predetermined time from the start of activation until the display changes to a displayable state; and
a control unit that controls an operation of the touch sensor and an operation of the display, characterized in that
the control unit performs control for starting, after starting the activation of the touch sensor, the activation of the display and causing the display to display a predetermined rendered image before elapse of the first predetermined time.

6. The display apparatus according to claim 5, characterized in that the control unit performs control for causing the display to display, after the elapse of the first predetermined time, a rendering position changing object that can change a rendering position on the display according to a detection result of the touch operation of the touch sensor.

7. The display apparatus according to claim 5, characterized in that the control unit performs control for causing the display to display a rendered image related to content of operation of the touch sensor.

8. A display apparatus comprising:
a touch sensor that detects touch operation;
a display unit that performs display related to content of operation by the touch sensor; and
a control unit that performs control of the display unit and the touch sensor, characterized in that
the control unit controls the display unit to perform display after the touch sensor changes to a usable state.
